(19) United States
(12) Patent Application Publication
(10) Pub. No.: US 2008/0176693 A1
(43) Pub. Date: Jul. 24, 2008

(54) Plate-link chain

(75) Inventor: Andre Teubert, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/002,311

(22) Filed: Dec. 15, 2007

Related U.S. Application Data
(60) Provisional application No. 60/875,015, filed on Dec. 15, 2006.

(51) Int. Cl. F16G 13/06; F16G 5/18

(52) U.S. Cl. 474/229; 474/238

(57) ABSTRACT

A plate-link chain for a belt-driven conical-pulley transmission having a continuously variable transmission ratio. Individual rocker joints that join chain links formed by plate sets are designed as pairs of rocker members inserted into openings in the plates and having rolling surfaces that bear against each other. Three plates lying side-by-side in the transverse direction of the plate-link chain and which are associated with three adjacent chain links in the longitudinal direction of the plate-link chain, form a plate subsequence. Outer plates of a plate subsequence in the transverse direction of the plate-link chain are situated in the same chain link with an outer plate of an adjacent plate subsequence that is adjacent in the transverse direction of the plate-link chain.

### BACKGROUND OF THE INVENTION

1. Field of the Invention

The present invention relates to a plate-link chain, particularly for belt-driven conical-pulley transmissions having a continuously variable transmission ratio, and wherein individual rocker joints that join adjacent chain links formed by plate sets are designed as pairs of rocker members that are inserted into openings in the plates and that have rolling surfaces that bear against each other.

2. Description of the Related Art

Plate-link chains are known in a great multitude of designs. For example, German patent publication DE 30 27 834 describes two-plate and three-plate forms for plate-link chains. In addition, European patent publication EP 0 800 018 describes an example of a belt-driven conical-pulley transmission having a continuously variable transmission ratio and in which such plate-link chains can be used.

Plate-link chains of that type are intended to improve the acoustic performance by providing individual chain links of differing pitch; that is, there is a sequence of links in which a short pitch and a long pitch occur. In a three-plate unit particularly, it is essential to prevent jamming of individual plates with each other. In addition, it is known to provide some plates with so-called overlap end tips. In that case, as a rule four different plate types are needed, namely a short plate type without an overlap end tip, a short plate type with an overlap end tip, a long plate type without an overlap end tip, and a long plate type with an overlap end tip. Even if only individual long plate types are installed in sequence, i.e., at least one link of short plates following a link of long plates, three different plate types are still needed, namely a short plate without an overlapping end tip, a short plate with an overlapping end tip, and a long plate.

An object of the present invention is to provide in a plate-link chain an arrangement of plates, especially short and long plates with different pitches, wherein overlap end tips can be dispensed with. Another object of the present invention is to reduce the number of plate types required.

### SUMMARY OF THE INVENTION

The objects are achieved by a plate-link chain, particularly for belt-driven conical-pulley transmissions having a continuously variable transmission ratio, and in which individual rocker joints that join chain links formed by plate sets are designed as pairs of rocker members inserted into openings in the plates and having rolling surfaces bearing against each other. Three plates lying side-by-side in the transverse direction of the plate-link chain, which belong to three adjacent links in the longitudinal direction of the plate-link chain, form a plate subsequence, and the outer plates of a plate subsequence in the transverse direction of the plate-link chain are situated in the same chain link with an outer plate of an adjacent plate subsequence that is adjacent in the transverse direction of the chain.

The term plate subsequence here means a plurality of plates lying side-by-side and overlapping on a rocker member, of chain links that are adjacent in the longitudinal direction, wherein the plate-link chain is assembled of plate subsequences of the same kind or plate subsequences that are arranged in mirror image in relation to the longitudinal direction of the plate-link chain. The term plate subsequence can also be regarded as a (random) formation of subsets, where the smallest possible number of plates are combined in such a way that it is possible to construct the entire plate-link chain of plate subsequences in modular fashion. The transverse direction of the plate-link chain means the direction along the rocker joints, i.e., the axial direction of the joint axis of the rocker joints. The longitudinal direction of the plate-link chain is the direction in which the chain is able to transmit force. Of course, the outer plates of a plate subsequence have no adjacent plates; the outer plates constitute outer plates of the plate-link chain.

Preferably, provision is made for an outer plate of a plate subsequence in the longitudinal direction of the plate-link chain, also referred to as the chain running direction, to be overlapped by the middle plate of the adjacent plate subsequence in the longitudinal direction of the plate-link chain. The middle plates of the plate subsequences thus ensure that outer plates of adjacent plate subsequences cannot perform any shifting motion along the rocker joints or rocker members, and also no swiveling motions around an axis perpendicular to the plane formed by the transverse and longitudinal directions of the plate-link chain.

Preferably, provision is made for adjacent plate subsequences that belong to the same chain links to be situated in mirror order in relation to a plane running in the longitudinal direction of the plate-link chain. If one observes a plurality of plate subsequences lying side-by-side in the transverse direction of the plate-link chain and belonging to the same three chain links, these are arranged in a sort of zigzag pattern, so that adjacent plate subsequences are the mirror image of each other.

Preferably, provision is also made for the chain links to have a pitch determined by the distance between joint axes of the joints, measured in the longitudinal direction of the plate-link chain, and for the plate-link chain to be made up of chain links having at least one short pitch and chain links of a long pitch, with the middle plates of at least part of the plate subsequences that belong to the same chain links having a long pitch. Part of the plate subsequences thus are made up of plates with the same pitch, while another part of the plate subsequences are made up of a mixture of plates with short and long pitch, with plates having long pitch lying in the middle of the plate subsequences, viewed in the longitudinal direction. Such plate subsequences thus belong to chain links in which a chain link having a long pitch in the longitudinal direction of the plate-link chain is bounded on both sides by chain links with a short pitch. A short pitch means that the spacing of the rocker joints is smaller than with the long pitch.

Preferably, provision is also made for the plate-link chain to include two types of plates, namely a plate with short pitch and a plate with long pitch. Additional specialized chain links are ignored here. Preferably, provision is also made for the plate-link chain to have a spread in pitch of more than 25%. Spread in pitch here means the difference in pitch between chain links and hence the plates with a short pitch, and the chain links and hence the plates with a long pitch. A plate-link chain in accordance with the invention can also include more than two pitches, for example chain links with a short, a medium, and a long pitch, or any number of pitches desired. With the arrangement of plates in accordance with the invention within the plate-link chain, it is possible to use one plate type per pitch. Thus, if the plate-link chain has five different pitches, for example, then five different plates would be necessary.

The objects identified at the beginning are also achieved by using a plate-link chain in accordance with the invention in a continuously variable, belt-driven conical-pulley transmission.

### BRIEF DESCRIPTION OF THE DRAWINGS

The structure, operation, and advantages of the present invention will become further apparent upon consideration of the following description, taken in conjunction with the accompanying drawings in which:

FIG. 1 is a top view of a known plate-link chain;

FIG. 2 is a side view of the plate-link chain shown in FIG. 1;

FIG. 3 is a top view of a known plate-link chain having a three-plate unit;

FIG. 4 is a top view of a plate-link chain in accordance with FIG. 3 with plates of different lengths;

FIG. 5 is a top view of a known plate-link chain with overlapping end tips;

FIG. 6 is a side view of a plate-link chain in accordance with FIG. 5;

FIG. 7 is a top view of another embodiment of a known plate-link chain having overlapping end tips;

FIG. 8 is a top view of the plate-link chain shown in FIG. 7 showing possible tilting motions of plates when overlapping end tips are not included in the plate-link chain; and

FIG. 9 is a top view of an embodiment of a plate-link chain in accordance with the present invention.

### DESCRIPTION OF THE PREFERRED EMBODIMENTS

FIG. 1 shows a top view of a detail of a known plate-link chain 1, as it is used as the endless torque-transmitting means in belt-driven conical-pulley transmissions (continuously variable transmissions, or CVTs). Such belt-driven conical-pulley transmissions have two conical pulleys about which the plate-link chain circulates. For continuous adjustment of the transmission ratio of such a belt-driven conical-pulley transmission, the axial spacings between the conical disks of each of the conical pulley pairs are adjusted in opposite directions.

Such a plate-link chain 1 is assembled from individual plates 2, which are situated in a plurality of rows I, II, III, etc., side-by-side in the longitudinal direction of the plate-link chain. At least some of the plates 2 of adjacent rows I, II, III, etc. are arranged at an offset from each other, so that rocker joints 3, which extend transversely through plate-link chain 1, effect a joined longitudinal and transverse structure of plate-link chain 1. Plates 2 lying side-by-side, transversely to the longitudinal direction L of plate-link chain 1, and which include the same rocker joints 3, form a plate set 15, which is also referred to as chain link 15.

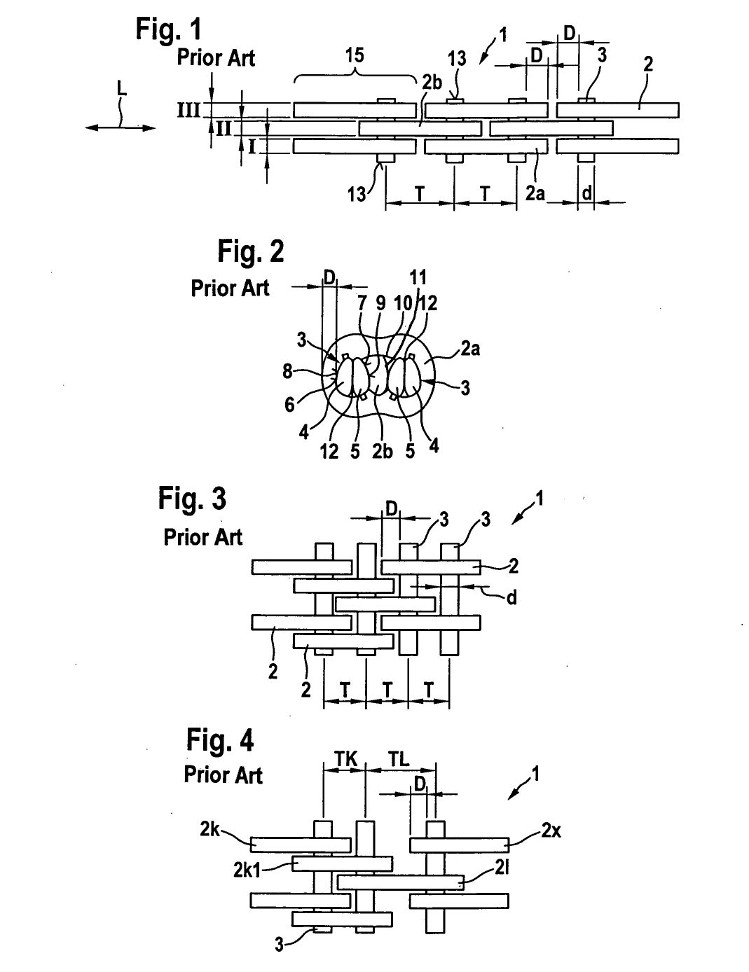

FIG. 2 shows a side view of a plate 2a of the chain shown in FIG. 1. As can be seen, each of the entire set of rocker joints designated with the reference label 3 is formed by a pair of rocker members 4, 5. The side surfaces 6, 7 of the respective rocker members 4, 5 that face away from each other bear against inner surfaces of an opening 10 in the respective plate. In the representation in FIG. 2, the side surface 6 of rocker member 4 bears against the inner surface 8 of plate 2a. A side surface 7 of rocker member 5 bears against an inner surface 9 of plate 2b, wherein the right edge of plate 2b is visible through the opening 10 and is designated in the representation of FIG. 2 by a line 11.

Instead of a single opening 10, the plates can have two openings that are separate from each other to receive each rocker joint; in that case the openings are not designed in the nature of one elongated opening, as shown in FIG. 2, but as two individual openings. The surfaces of each rocker member pair 4, 5 that face each other form rolling surfaces 12, at which the rocker members roll against each other when the plate-link chain bends as it passes around a pulley. Two rolling surfaces 12 of two rocker members 4, 5 that roll against each other are in contact with each other along a pitch line that is formed along the rocker members 4, 5.

The spacing in the longitudinal direction of the chain between two axes of rotation or pitch lines of the rocker joints 3 are designated in FIG. 1 as the pitch T of the plate-link chain. The pitch T is thus designated by the interval between two pitch lines within a chain link 15.

The end faces 13 of the rocker members 4, 5 that extend laterally outwardly from the sides of plate-link chain 1 form contact surfaces, which come into frictional contact with the conical surfaces of the pulleys of a belt-driven conical-pulley transmission.

FIG. 1 shows a plate-link chain 1 using the so-called two-plate structure, in which the arrangement of the plates 2 repeats after every two pitches, or in the lateral direction of the chain preferably every two rows. As can be seen, the pitch T is determined by twice the diameter d of a pin and twice the longitudinal length D of a plate end loop of the plates, plus a slight space between successive plates.

A significantly smaller pitch T is achieved with the so-called three-plate structure in accordance with FIG. 3, in which the pattern repeats after every three pitches, or preferably every three rows in the transverse direction of the plate-link chain. As can be seen, the pitch T for the three-plate structure is twice the thickness of the rocker members or twice the diameter d of a pin 3, plus the longitudinal length D of a plate end loop of a plate 2, plus a small space between the plate and the rocker joint or rocker member. The three-plate structure shown in FIG. 3 has a smaller pitch T than the two-plate structure shown in FIG. 1.

FIG. 4 shows a detail similar to the representation in FIGS. 1 and 3 of a plate-link chain with two different pitches T, namely a short pitch TK and a long pitch TL. Differing pitches TK and TL are possible by using two different types of plates, namely a short plate 2k and a long plate 2l, which differ essentially only by the difference in the lengths of their openings 10 measured in the longitudinal direction of the plate-link chain (see FIG. 2) and hence the total length of the plate 2. A plate-link chain 1 with different pitches is advantageous for reasons of the acoustic excitation of the plate-link chain or of the conical disks, and thus of sound comfort, since with different chain pitches and hence different intervals between end faces 13 within the plate-link chain 1, individual tone excitations can be reduced or suppressed.

One problem that arises with a design of the plate-link chain shown in FIG. 4, which is arranged in the same three-plate structure as the chain shown in FIG. 3, is that the plate 2x, which can be a short or a long plate and follows to the right after the topmost plate 2k as shown in FIG. 4, no longer overlaps the plate 2k1 that follows after plate 2k in the adjacent row to the right, so that plate 2x can shift laterally, transversely to the longitudinal direction of plate-link chain 1 with respect to the rocker joint 3 or the pair of rocker members 4, 5.

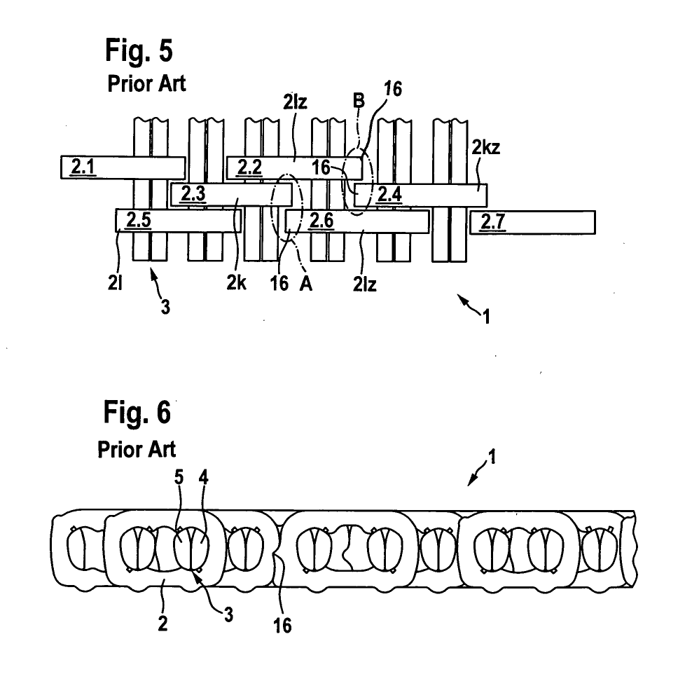

In order to prevent that lateral shifting of individual plates within a plate set 15, it is known to provide overlap end tips 16 on some plates 2 as shown in FIGS. 5 and 6. FIG. 5 thus shows a detail of a plate-link chain 1 in a top view similar to the top views of FIGS. 1, 3, and 4. FIG. 6 shows a side view similar to the side view of FIG. 2. FIGS. 5 and 6 show plate sets or chain links 15 that have either a long pitch TL or a short pitch TK. Plates 2 of a chain link 15 having a long pitch TL are designated as plates 2l; similarly, plates 2 of a chain link 15 having a short pitch TK are designated as plates 2k. In addition, the plates 2 shown in FIG. 5 are numbered sequentially as plates 2.1, 2.2, 2.3, etc. through 2.7.

A long plate 2lz identified by the reference numeral 2.6 in FIG. 5 includes an overlap end tip 16, whose design is visible in the side view of FIG. 6. The long plate 2lz identified by the reference numeral 2.2 also has an overlap end tip 16, which, however, is covered up in FIG. 6 and is not visible in that view. The overlap end tip 16 ensures that an overlap A is always produced with a plate of an adjacent chain link 15 in an adjacent row; here it is the plate numbered 2.3. An overlap end tip 16 of the same kind is included on the plate 2kz identified by the reference numeral 2.4 in FIG. 5, so that the latter always has an overlap B with the plate 2lz identified by the reference numeral 2.2. Such overlap end tips 16 are needed in particular with a pitch spread of more than 25%. Pitch spread means the difference in length between long and short plates, and thus the difference between the short pitch TK and the long pitch TL. The overlap end tips 16 thus ensure that the plates cannot shift to the side, especially in the area of the long plates 2l, which would result in jamming of the plate-link chain 1. Using the overlap end tips 16 necessitates the utilization of four different plate types, namely a short plate 2k, a short plate with an overlap end tip 2kz, a long plate 2l, and a long plate with an overlap end tip 2lz.

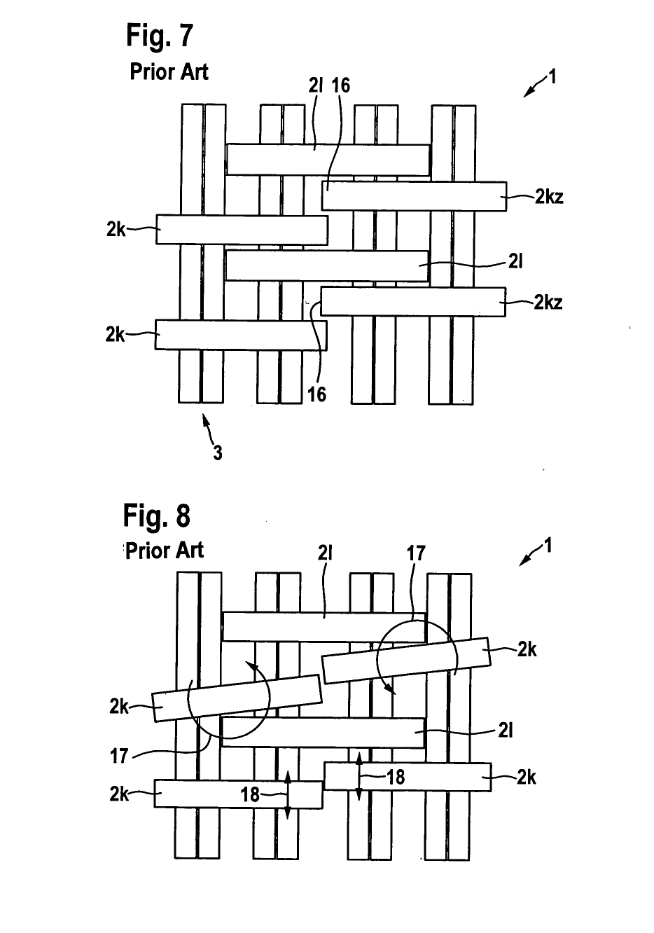

A reduction to three different plate types is possible with a plate sequence as shown in FIG. 7. The illustration shows a typical plate sequence or pitch sequence with short pitch TK—long pitch TL—short pitch TK, in which the short plates 2kz are provided with overlap end tips to prevent plates from jamming. The overlap end tips 16 ensure that adjacent chain links 15 with short plates 2k, 2kz cannot shift over each other laterally, resulting in jamming of the plate-link chain 1. If the overlap end tips 16 were not present, jamming of the plates as shown in FIG. 8 could occur, where the short plates with tips 2kz of FIG. 7 are replaced by short plates 2k without end tips. As can be seen in FIG. 8, adjacent plates 2k in a row with short pitch can twist, indicated by circular arrows 17, and thus can jam. It is also possible, however, that plates in adjacent chain links 15 in adjacent rows can shift, indicated by arrows 18, and thereby also cause jamming.

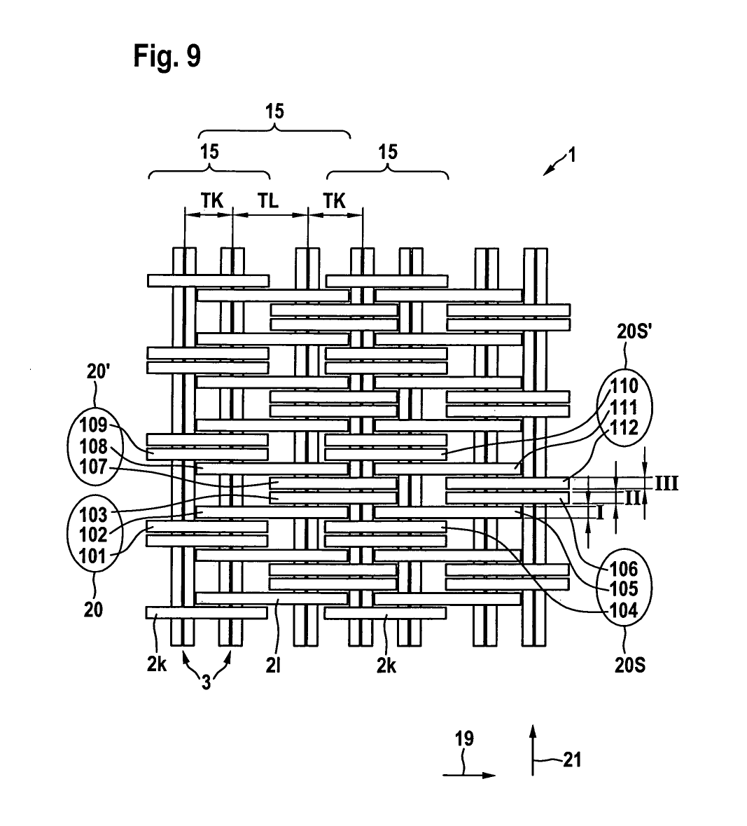

FIG. 9 shows an embodiment of a plate-link chain 1 in accordance with the present invention. Chain 1 of FIG. 9 includes chain links 15 with a short pitch TK and chain links 15 with a long pitch TL, and is composed of two different plate types, namely short plates 2k and long plates 2l, and in which jamming of plates 2k, 2l among each other is reliably prevented despite the absence of overlap end tips 16. The short plates 2k form chain links 15 with short pitch TK, while the long plates 2l form long chain links 15 with long pitch TL. With the plate sequence in accordance with the invention, as shown as an exemplary embodiment in FIG. 9, the use of plates 2 having overlap end tips 16 can be dispensed with. In that way it is possible to produce a plate-link chain 1 having a three-plate structure and including two different pitches TL, TK, which is made up of only two different plate types and in which there is nevertheless no danger of tilting of individual plates.

To make it easier to distinguish individual plates 2 from each other, and to make it easier to distinguish the plate designations from the designations shown in FIGS. 1 through 8, the plates in FIG. 9 are numbered sequentially beginning with the reference numeral 101. As can be seen, this is a three-plate structure, which begins with the plate 101, for example, which is a short plate 2k with the short pitch TK, followed by and overlapped by a plate 102, plate 102 being a long plate 2l with the long pitch TL. The latter, in turn, is followed and overlapped by a plate 103, which is a short plate 2k with the short pitch TK. In the longitudinal direction of plate-link chain 1 this is followed by the same sequence of plates 2, designated here as 104 for a short plate 2k, 105 for a long plate 2l, and 106 for a short plate 2k. Plates 101 and 104 are arranged in a row I, plates 102 and 105 in a row II, and plates 103 and 106 in a row III. In the longitudinal direction of the plate-link chain viewed toward the right in the drawing plane of FIG. 9, the direction toward the right of the longitudinal direction being identified by an arrow having the reference numeral 19 (longitudinal direction thus means the direction of the arrow as well as the direction opposing the arrow), plates 2 that are arranged overlapping side-by-side on a rocker joint 3 are stacked in the upward direction in the view of FIG. 9, which direction is identified by an arrow 21. Plate 102 is thus stacked on plate 101 with a lateral offset in the direction of arrow 21, and plate 103 is correspondingly stacked on plate 102 with a lateral offset in the direction of arrow 21. That pattern is repeated with the plates 104, 105, 106, where plate 104 is, of course, offset from plate 103 in a direction opposite to the direction represented by arrow 21.

As can be seen from FIG. 9, the long plates 21, which in this case are the plates 102 and 105, always overlap the first or last plate of the preceding or following plate subsequence 20, respectively. Plate subsequence 20 here means in each case a sequence of plates 2 that forms the three-plate structure, such as here, for example, the series of plates 101, 102, and 103, which make a plate subsequence 20, and the series of plates 104, 105, and 106, which make a plate subsequence 20S. Long plate 102 here overlaps the first short plate of the adjacent plate subsequence 20S, in this case plate 104. Correspondingly, plate 105 overlaps the first short plate of the adjacent subsequence 20, in this case plate 103.

In the transverse direction of the plate-link chain, identified by arrow 21 in FIG. 9, the plate subsequences 20 and 20′ of the rows I, II and III are followed by plate subsequences 20, which in relation to a plane running in the longitudinal direction are formed in the mirror image of the plate subsequences 20 and 20′. Starting from a plate 107 in the same chain link as plate 101, the adjacent plates of plate subsequence 20 follow in the longitudinal direction, not in the direction of arrow 21, i.e., plates stacked upward in the representation in FIG. 9, but rather contrary to the direction of arrow 21, and hence downward stacked plates 108, 109. Plates 107, 108, and 109 form a plate set 20′, which is the mirror image of the plate set 20. Correspondingly, the subsequent plates 110, 111, and 112 form a plate set 20S′ that is arranged as the mirror image of plate set 20S.

The long plates within the plate set, i.e., in FIG. 9 plate 102 in plate set 20, plate 105 in plate set 20S, plate 108 in plate set 20′, and plate 111 in plate set 20S′, are all arranged so that they overlap with a short plate of an adjacent plate set. For example, plate 102 of plate set 20 overlaps with plate 104 of the adjacent plate set 20S. Plate 108 of plate set 20′ overlaps with plate 110 of the adjacent plate set 20S′, and plate 111 of plate set 20S′ overlaps with plate 107 of plate set 20′. An arrangement of that type ensures that no plate has the possibility of tilting due to a shifting motion along the rocker joints, or due to a tilting motion with another plate.

Within a plate subsequence 20 the plate sequence in accordance with the invention has the sequence of a short plate, a long plate, and after that again a short plate, or the sequence of three short plates.

Plate subsequences 20 are always set with the outer plates in the transverse direction of the plate-link chain 1 completely overlapping the next subsequence 20, as is the case for example with the plates 103 and 107 and the plates 106 and 112. Plates of plate subsequences 20 that are adjacent in the transverse direction of plate-link chain 1 are thus situated in the plate-link chain 1 not so that they overlap, but so that they are congruent.

The previously shown sequence of the plates within the plate-link chain also guarantees that the respective end plates of the plate-link chain, i.e. the plates that are situated on the outside in the transverse direction of the plate-link chain, are short plates.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A plate-link chain for a belt-driven conical-pulley transmission having a continuously variable transmission ratio, of which chain individual rocker joints that join chain links formed by plate sets are designed as pairs of rocker members positioned in openings in the plates and having rolling surfaces that bear against each other, said chain comprising: three plates lying side-by-side in a transverse direction of the plate-link chain, wherein the three plates are associated with three adjacent chain links in a longitudinal direction of the plate-link chain to form a plate subsequence, and wherein plates of a plate subsequence that are outer plates in the transverse direction of the plate-link chain are situated in the same chain link with a plate of an adjacent plate subsequence that is adjacent in the transverse direction.

2. A plate-link chain in accordance with claim 1, wherein an outer plate of a plate subsequence in the longitudinal direction of the plate-link chain, is overlapped in the longitudinal direction of the plate-link chain by a middle plate of an adjacent plate subsequence.

3. A plate-link chain in accordance with claim 2, wherein adjacent plate subsequences that are associated with the same chain links are situated in mirror relationship in relation to a plane running in the longitudinal direction of the plate-link chain.

4. A plate-link chain in accordance with claim 2, wherein the chain links have a pitch determined by a distance between joint axes of the rocker joints measured in the longitudinal direction of the plate-link chain, and wherein the plate-link chain is composed of chain links having at least one short pitch plate and one long pitch plate, with middle plates of at least part of the plate subsequences associated with the same chain links having a long pitch.

5. A plate-link chain in accordance with claim 4, wherein the plate-link chain is formed from two types of plates in the form of a first plate having a first pitch and a second plate having a second pitch, wherein the second pitch is larger than the first pitch.

6. A plate-link chain in accordance with claim 5, wherein the plate-link chain has a pitch spread of more than 25%.

7. A belt-driven conical-pulley transmission having a continuously variable transmission ratio and including a plate-link chain in accordance with claim 1.
